(19) United States
(12) Patent Application Publication
(10) Pub. No.: US 2003/0114562 A1
(43) Pub. Date: Jun. 19, 2003

(54) Tinting composition and method of use

(75) Inventors: Arif M. Sitabkhan, Westlake, OH (US); Michael W. Howe, The Woodlands, TX (US); Roderic Mathews, The Woodlands, TX (US); Jiafu Fang, Spring, TX (US); Anne M. Brun, The Woodlands, TX (US)

Correspondence Address: JENKENS & GILCHRIST, A PROFESSIONAL CORPORATION, 1100 LOUISIANA, SUITE 1800, HOUSTON, TX, 77002-5214, US

(73) Assignee: Pennzoil-Quaker State Company, Houston, TX

(21) Appl. No.: 10/185,519

(22) Filed: Jun. 27, 2002

Related U.S. Application Data
(60) Provisional application No. 60/301,276, filed on Jun. 27, 2001.

(51) Int. Cl. C08L 1/00

(52) U.S. Cl. 524/261

(57) ABSTRACT

A tinting composition for tinting a surface which includes a solvent, a film former, and a pigment, such as iron oxide, titanium dioxide, mica, calcium sodium borosilicate, organic constituent containing pigments, inorganic constituent containing pigments, fluorescent constituent containing pigments, phosphorescent constituent containing pigments, luminescent constituent containing pigments, ultraviolet absorbing pigments, mineral constituent containing pigments, amorphous glass oxides, polyacrylates, metal flakes, reflective pigments, and mixtures thereof. A method of tinting a surface which includes selecting a surface for tinting; mixing a solvent, a film former and a pigment to form a tinting composition; and applying the tinting composition to the surface.

### PRIOR RELATED APPLICATIONS

This application claims priority to previously filed U.S. Provisional Application Serial No. 60/301/276 filed on Jun 27, 2001 and previously filed U.S. Patent Application No. 09/695,177 filed on Oct. 24, 2000, both of which are hereby incorporated by reference in their entirety.

### FEDERALLY SPONSORED RESEARCH STATEMENT

Not applicable.

### REFERENCE TO MICROFICHE APPENDIX

Not applicable.

### FIELD OF THE INVENTION

This invention relates to a composition for tinting surfaces and methods of using the composition. More particularly, the invention relates to a composition for tinting polymeric substrates such as rubber, engineered plastics, and vinyl, metals, glass, fiberglass, paint, and plastics and methods of using the composition.

### BACKGROUND OF THE INVENTION

Increasingly, consumers are expending money on accessories for thier vehicles. Consumers often wish to modify the surface color of accessories used on or inside thier vehicle to either coordinate or contrast that accessory with other parts of their vehicle or to accentuate that color. Examples of accessories that consumers may wish to modify in color to coordinate or contrast with other parts of their vehicle or to accentuate include, but are not limited to, polymeric substrates such as rubber, engineered plastic, and vinyl accessories, metal accessories, glass accessories, fiberglass accessories, painted accessories, and plastic accessories.

Examples of polymeric substrates such as rubber and vinyl accessories on vehicles that consumers may wish to modify in color include, but are not limited to, tires, dashboards, bumpers, seats, steering wheels, and mudflaps. Engineered plastic accessories on vehicles that consumers may wish to modify in color include, but are not limited to, bumpers, body panels, trim, and consoles. Metal accessories on vehicles that consumers may wish to modify in color include, but are not limited to, bumpers, rims, grills and hitches. Also, glass accessories on vehicles that consumers may wish to modify in color include, but are not limited to, windshields and mirrors. Certain fiberglass accessories on vehicles that consumers may wish to modify in color include, but are not limited to, body panels. Painted accessories on vehicles that consumers may wish to modify in color include, but are not limited to, exterior vehicle paint. Certain plastic accessories on vehicles that consumers may wish to modify in color include, but are not limited to, bumpers, headlights, and mirror casings.

Although consumers may wish to alter the surface color of the accessories used on or inside their vehicles to coordinate or contrast that color with other parts of their vehicle or to accentuate that color, often times consumers only desire to make the color change on a temporary, nonpermanent basis. Accordingly, a need exists for a tinting composition which consumers can safely handle and apply to accessories on or inside their vehicles or other surfaces not necessarily associated with vehicles to temporarily impart a color of their choice to the surface of the accessory.

### SUMMARY OF THE INVENTION

The embodiments of the invention meet the above need by providing a tinting composition which includes a solvent, a film former, and a pigment. In some embodiments, the composition does not include (i.e., substantially free of) a pigment and thus is clear. It can form a protective coating on the surface. The composition may be applied to a variety of surfaces including tires, glass, and plastic. The composition may be applied to the surface by sponging, dabbing, painting and wiping the tinting composition onto the surface.

### BRIEF DESCRIPTION OF THE DRAWINGS

Not applicable.

### DESCRIPTION OF EMBODIMENTS OF THE INVENTION

Embodiments of the invention provide a new tinting composition that is capable of temporarily tinting a surface, for example, the exterior of an automobile. The tinting composition comprises a solvent, a film former, and a pigment. Other optional additives may also be used. In some embodiments, the composition includes water; in other embodiments, the composition is substantially free of water. Although preferred uses of the tinting composition are directed to vehicles and vehicle accessories, other surfaces can be tinted. Examples of suitable surfaces which can be tinted by the tinting composition include, but are not limited to, polymeric substrates such as rubber, engineered plastics, and vinyl, metal, glass, fiberglass, painted surfaces, and plastic surfaces.

In some embodiments, the solvent is selected from the group consisting of branched or straight chained aliphatic hydrocarbons, synthetic hydrocarbons, alcohols, water, organic solvents, silicone fluids, paraffinic solvents, volatile solvents, and mixtures thereof. The pigment is selected from the group consisting of iron oxide, titanium dioxide, mica, calcium sodium borosilicate, organic constituent containing pigments, inorganic constituent containing pigments, fluorescent constituent containing pigments, phosphorescent constituent containing pigments, luminescent constituent containing pigments, ultraviolet absorbing pigments, mineral constituent containing pigments, amorphous glass oxides, polyacrylates, metal flakes, reflective pigments, or mixtures thereof.

Embodiments of the invention also provide a new method of tinting a surface. The method includes selecting a surface for tinting, mixing a solvent, a film former and a pigment to form a tinting composition, and applying the tinting composition to the surface and optionally includes the step of drying the tinting composition. The solvent is selected from the group consisting of branched or straight chained aliphatic hydrocarbons, synthetic hydrocarbons, alcohols, water, organic solvents, silicone fluids, paraffinic solvents, volatile solvents, and mixtures thereof. The pigment is selected from the group consisting of iron oxide, titanium dioxide, mica, calcium sodium borosilicate, organic constituent containing pigments, inorganic constituent containing pigments, fluorescent constituent containing pigments, phosphorescent constituent containing pigments, luminescent constituent containing pigments, ultraviolet absorbing pigments, mineral constituent containing pigments, amorphous glass oxides, polyacrylates, metal flakes, reflective pigments, or mixtures thereof.

When applied to the surface, the tinting composition is liquid in form. The tinting composition can be applied in various manners to the surface. It is contemplated that the tinting composition may be applied to the surface by spraying the tinting composition onto the surface with a spray trigger or an aerosol can; by sponging, dabbing, painting, or wiping the tinting composition onto the surface with a cloth, brush, sponge, pen, marker, or similar application means; by applying an adhesive which contains the tinting composition to the surface and then removing the adhesive; or by any other suitable means for applying the tinting composition to the surface. Once the tinting composition has been applied to the surface, the tinting composition dries and imparts a color and sheen to the surface. The drying time depends upon the length of time required for the solvent in the tinting composition to evaporate and is affected by the ventilation and the ambient conditions such as the humidity level and the temperature. The drying time can vary from about 10 minutes to about an hour depending on the ambient conditions and the solvent selected. The drying can be accomplished by allowing the tinting composition to be exposed to the ambient conditions or by applying heat to the tinting composition.

Once the tinting composition has been applied to the surface, the composition will remain on the surface for days to months. The length of time that the tinting composition remains on the surface depends upon a variety of conditions such as the ambient and environmental conditions, the amount of tinting composition which has been applied to the surface, the driving conditions to which the tinting composition is subjected, and the amount of abrasion to which the tinting composition is subjected. The tinting composition will eventually fade and/or peel and will need to be reapplied to the surface should the consumer wish to again impart a tint to the surface. Should the consumer desire to remove the tinting composition from the surface before it fades and/or peels, one can use a cleaning solution and optionally a brush to remove the tinting composition. In some embodiments, the tinting composition, after drying on a substrate, can be easily peeled by hand. In other words, the tinting composition forms a peelable coating after being applied to a substrate. In some cases, one or more peeling aids are used to improve the peelability of the coating.

The selection of the solvent for use in the tinting composition depends on a variety of factors such as the desired drying time of the tinting composition, the flowability of the tinting composition, the desired degree of dispersing of the pigment in the tinting composition, and environmental considerations. Generally, the solvent is present in the tinting composition in an amount from about 0.1 to about 99.9 wt. % of the tinting composition. In certain embodiments, the solvent is present in an amount from about 50 to about 99.9 wt. % of the tinting composition. In certain other embodiments, the solvent is present in an amount from about 75 to about 99.9 wt. % of the tinting composition.

Examples of suitable solvents for use in the tinting composition include, but are not limited to, branched or straight chained aliphatic hydrocarbons, synthetic hydrocarbons, alcohols, water, organic solvents, silicone fluids, paraffinic solvents, volatile solvents, and mixtures thereof. Examples of suitable branched or straight chained aliphatic hydrocarbons include, but are not limited to, Shell Sol 71 and Shell Sol 142HT made by Shell Chemical Company, 2251 Oil made by Penreco, and Conosol® C145 made by Penreco. Examples of suitable synthetic hydrocarbons include, but are not limited to, synthetic isoparaffinic hydrocarbons such as Isopar® M made by ExxonMobil Chemical Company. Examples of suitable alcohols include, but are not limited to, methanols, ethanols, propanols, and tert-butyl alcohols. Examples of suitable organic solvents include acetone, hexane, toluene, esters, volatile aldehydes, and volatile ketones. Examples of suitable silicone fluids include, but are not limited to, polydimethylsiloxane, functional silicone polymers, silicone resins, volatile silicones, and silanes. Examples of suitable functional silicone polymers include, but are not limited to, silicones containing amine functional groups, fluorinated functional groups, hydroxy terminated functional groups, cyclic functional groups, vinyl functional groups, and ethoxy functional groups. Where silicone fluids are used as the solvent in the tinting composition, the preferred viscosity range is from about 0.65 to about 12,000,000 cst. Examples of suitable paraffinic solvents include, but are not limited to, Isopar® M made by ExxonMobil Chemical Company. Examples of suitable volatile solvents include, but are not limited to, cyclic silicones, acetone, and mineral spirits.

Suitable solvents include, but are not limited to the following compounds identified by their INCI names: 1,2,6-Hexanetriol; 3-Hexenol; Acetone; Alcohol; Alcohol Denat.; Amyl Acetate; Aqua; Arachis Hypogaea; Benzaldehyde; Benzyl Alcohol; Benzyl Benzoate; Bertholletia Excelsa; Brevoortia; Bubulum; Butoxydiglycol; Butoxyethanol; Butyl Acetate; Butylene Glycol; Butyrolactone; C₁₀₋₁₁ Isoparaffin; C₁₀₋₁₃ Isoparaffin; C₁₀₋₁₈ Triglycerides; C₁₁₋₁₂ Isoparaffin; C₁₁₋₁₃ Isoparaffin; C₁₂-14 Isoparaffin; C₁₃₋₁₄ Isoparaffin; C₁₃₋₁₆ Isoparaffin; C₂₀₄₀ Isoparaffin; C₇₋₈ Isoparaffin; C₈₋₉ Isoparaffin; C₉₋₁₁ Isoparaffin; C₉₋₁₃ Isoparaffin; C₉₋₁₄ Isoparaffin; Caprylic/Capric/Lauric Triglyceride; Caprylic/Capric/Stearic Triglyceride; Caprylic/Capric Triglyceride; Cocos Nucifera; Coenzyme A; Cyclohexane; Cyclomethicone; Deodorized Kerosene; Diacetin; Diacetone Alcohol; Dibutyl Phthalate; Dichloromethane; Diethoxyethyl Succinate; Diethyl Phthalate; Diethylene Glycol; Dimethoxydiglycol; Dimethyl Ether; Dimethyl Isosorbide; Dimethyl Phthalate; Dimethyl Sulfone; Dipentene; Diphenyl Methane; Dipropylene Glycol; Ethoxydiglycol; Ethoxydiglycol Acetate; Ethoxyethanol; Ethoxyethanol Acetate; Ethyl Acetate; Ethyl Hexanediol; Ethylene Carbonate; Furfural; Glycereth-12; Glycereth-26; Glycereth-7; Glycerin; Glyceryl Triacetyl Hydroxystearate; Glyceryl Triacetyl Ricinoleate; Glycofurol; Glycol; Heptane; Hexane; Hexyl Alcohol; Hexyldecanol; Hexylene Glycol; Hydrogenated Menhaden Oil; Hydroxyethyl Pei-1000; Hydroxyethyl Pei-1500; Isoamyl Acetate; Isobutoxypropanol; Isobutyl Acetate; Isocetyl Salicylate; Isohexadecane; Isopentane; Isopropyl Acetate; Isopropyl Alcohol; Isopropyl Myristate; Isopropyl Palmitate; Isopropyl Ppg-2-Isodeceth-7 Carboxylate; Lanolin; Mek; Methoxydiglycol; Methoxyethanol; Methoxyisopropanol; Methoxymethylbutanol; Methyl Acetate; Methyl Alcohol; Methyl Hexyl Ether; Methylal; Methylpropanediol; Mibk; Mineral Spirits; Mixed Terpenes; N-Butyl Alcohol; Octyldodecanol; Olea Europaea; Papaver Orientale; Paraffinum Liquidum; PEG/PPG-17/6 Copolymer; PEG/PPG-18/4 Copolymer; PEG/PPG-23/50 Copolymer; PEG/PPG-296/57 Copolymer; PEG-10; PEG-12; PEG-135; PEG-14; PEG-150; PEG-16; PEG-18; PEG-20; PEG-200; PEG-32; PEG-350; PEG-4; PEG-40; PEG-6; PEG-6 Methyl Ether; Peg-75; PEG-8; PEG-9; PEG-90; Pelargonic Acid; Pentane; Petroleum Distillates; Phenoxyisopropanol; Phenylpropanol; PPG-2 Methyl Ether; PPG-3 Methyl Ether; Propyl Acetate; Propyl Alcohol; Propylene Carbonate; Propylene Glycol; Sorbeth-20; T-Butyl Alcohol; Tallol; Taraktogenos Kurzii; Terpineol; Tetrahydrofurfuryl Acetate; Tetrahydrofurfuryl Alcohol; Thiolanediol; Toluene; Triacetin; Tributyl Citrate; Tributylcresylbutane; Tricaprin; Trichloroethane; Triethyl Citrate; Triethylene Glycol; Trihydroxystearin; Triisononanoin; Triisostearin; Trilaurin; Trilinolein; Trimethylhexanol; Trimyristin; Trioctanoin; Triolein; Tripalmitin; Tristearin; Triundecanoin; Turpentine; Xylene; and Zea Mays.

As mentioned above, the tinting composition comprises one or more film formers. Any film formers may be used in embodiments of the invention. Suitable film formers include, but are not limited to the following compounds identified by their respective INCI names: Acrylamide/sodium acrylate copolymer; Acrylamides/acrylates/DMAPA/methoxy PEG methacrylate copolymer; Acrylamides copolymer; Acrylamidopropyltrimonium chloride/acrylates copolymer; Acrylates/acetoacetoxyethyl methacrylate copolymer; Acrylates/acrylamide copolymer; Acrylates/ammonium methacrylate copolymer; Acrylates/C₁₀₋₃₀ alkyl acrylate crosspolymer; Acrylates/diacetoneacrylamide copolymer; Acrylates/octylacrylamide copolymer; Acrylates/PVP copolymer; Acrylates/steareth-50 acrylate copolymer; Acrylates/VA copolymer; Acrylates/VA crosspolymer; Acrylates copolymer; Acrylic acid/acrylonitrogens copolymer; Adipic acid/diethylene glycol/glycerin crosspolymer; Adipic acid/diethylenetriamine copolymer; Adipic acid/dimethylaminohydroxypropyl diethylenetriamine copolymer; Adipic acid/epoxypropyl diethylenetriamine copolymer; Adipic acid/isophthalic acid/neopentyl glycol/trimethylolpropane copolymer; Albumen; Allyl stearate/VA copolymer; Aminoethylacrylate phosphate/acrylates copolymer; Ammonium acrylates/acrylonitrogens copolymer; Ammonium acrylates copolymer; Ammonium alginate; Ammonium VA/acrylates copolymer; AMP-acrylates/diacetoneacrylamide copolymer; AMP-acrylates copolymer; AMPD-acrylates/diacetoneacrylamide copolymer; Bayberry wax; Behenyl/isostearyl beeswax; Benzoic acid/phthalic anhydride/pentaerythritol/neopentyl glycol/palmitic acid copolymer; Butadiene/acrylonitrile copolymer; Butoxy chitosan; Butyl benzoic acid/phthalic anhydride/trimethylolethane copolymer; Butyl benzyl phthalate; Butyl ester of ethylene/MA copolymer; Butyl ester of PVM/MA copolymer; Butyl phthalyl butyl glycolate; Butylated polyoxymethylene urea; Butylated PVP; Calcium/sodium PVM/MA copolymer; Calcium carrageenan; Candelilla cera; Carboxymethyl chitosan succinamide; Carboxymethyl hydroxyethylcellulose; Carnauba; Cellulose acetate; Cellulose acetate butyrate; Cellulose acetate propionate; Cellulose gum; Cetyl hydroxyethylcellulose; Chitosan succinamide; Collodion; Corn starch/acrylamide/sodium acrylate copolymer; Dilinoleic acid/ethylenediamine copolymer; Dimethicone/mercaptopropyl methicone copolymer; Dimethicone/sodium PG-propyldimethicone thiosulfate copolymer; Dimethyl phthalate; DMAPA acrylates/acrylic acid/acrylonitrogens copolymer; DMHF; Dodecanedioic acid/cetearyl alcohol/glycol copolymer; Ethyl ester of PVM/MA copolymer; Ethylcellulose; Ethylene/acrylic acid/VA copolymer; Ethylene/acrylic acid copolymer; Ethylene/calcium acrylate copolymer; Ethylene/MA copolymer; Ethylene/VA copolymer; Glyceryl alginate; Glyceryl hydrogenated rosinate; Glyceryl polyacrylate; Glyceryl rosinate; Glycosaminoglycans; Guar hydroxypropyltrimonium chloride; Gutta percha; Hydrogenated styrene/methyl styrene/indene copolymer; Hydrolyzed collagen; Hydrolyzed elastin; Hydrolyzed keratin; Hydroxybutyl methylcellulose; Hydroxyethyl ethylcellulose; Hydroxyethylcellulose; Hydroxylated lanolin; Hydroxypropyl guar; Hydroxypropyl methylcellulose; Hydroxypropylcellulose; Isobutylene/sodium maleate copolymer; Isopropyl ester of PVM/MA copolymer; Lanolin cera; Lauryl acrylate/VA copolymer; Maltodextrin; Methacryloyl ethyl betaine/acrylates copolymer; Methyl hydrogenated rosinate; Methyl methacrylate crosspolymer; Methyl rosinate; Nonoxynyl hydroxyethylcellulose; Oat beta glucan; Octylacrylamide/acrylates/butylaminoethyl methacrylate copolymer; Oleoyl hydrolyzed collagen; PEG-8/SMDI copolymer; PEG-crosspolymer; Pentaerythrityl hydrogenated rosinate; Pentaerythrityl rosinate; Phthalic anhydride/adipic acid/castor oil/neopentyl glycol/PEG-3/trimethylolpropane copolymer; Phthalic anhydride/benzoic acid/trimethylolpropane copolymer; Phthalic anhydride/butyl benzoic acid/propylene glycol copolymer; Phthalic anhydride/glycerin/glycidyl decanoate copolymer; Phthalic anhydride/trimellitic anhydride/glycols copolymer; Polyacrylamide; Polyacrylamidomethylpropane sulfonic acid; Polyacrylic acid; Polybutylene terephthalate; Polydimethylaminoethyl methacrylate; Polyglucuronic acid; Polyglycerylmethacrylate; Polymethacrylamidopropyltrimonium chloride; Polymethyl acrylate; Polymethyl methacrylate; Polyoxyisobutylene/methylene urea copolymer; Polyquaternium-1; Polyquaternium-10; Polyquaternium-11; Polyquaternium-12; Polyquaternium-13; Polyquatemium-14; Polyquatemium-15; Polyquaternium-16; Polyquaternium-17; Polyquaternium-18; Polyquatemium-19; Polyquaternium-2; Polyquaternium-20; Polyquatemium-22; Polyquatemium-24; Polyquaternium-27; Polyquatemium-28; Polyquatemium-29; Polyquaternium-30; Polyquaternium-3 1; Polyquaternium-32; Polyquatemium-33; Polyquaternium-34; Polyquatemium-35; Polyquaternium-36; Polyquatemium-37; Polyquatemium-39; Polyquaternium-4; Polyquatemium-42; Polyquaternium-5; Polyquatemium-6; Polyquatemium-7; Polyquaternium-8; Polyquaternium-9; Polysilicone-6; Polystyrene; Polyurethane; Polyvinyl acetate; Polyvinyl alcohol; Polyvinyl butyral; Polyvinyl imidazolinium acetate; Polyvinyl laurate; Polyvinyl methyl ether; Potassium carrageenan; Potassium hyaluronate; PPG-26/TDI copolymer; PPG-51/SMDI copolymer; Procollagen; PVM/MA copolymer; PVP; PVP/decene copolymer; PVP/dimethylaminoethylmethacrylate copolymer; PVP/eicosene copolymer; PVP/hexadecene copolymer; PVP/VA/itaconic acid copolymer; PVP/VA/vinyl propionate copolymer; PVP/VA copolymer; Rosin acrylate; Rosin hydrolyzed collagen; Shellac; Shellac cera; Sodium acrylate/vinyl alcohol copolymer; Sodium carrageenan; Sodium DVB/acrylates copolymer; Sodium polyacrylate starch; Sodium polymethacrylate; Sodium polystyrene sulfonate; Sodium PVM/MA/decadiene crosspolymer; Sodium styrene/acrylamide copolymer; Sodium styrene/acrylates copolymer; Sodium tauride acrylates/acrylic acid/acrylonitrogens copolymer; Soluble collagen; Starch/acrylates/acrylamide copolymer; Starch diethylaminoethyl ether; Steareth-10 allyl ether/acrylates copolymer; Stearylvinyl ether/MA copolymer; Styrene/acrylates/acrylonitrile copolymer; Styrene/acrylates/ammonium methacrylate copolymer; Styrene/allyl benzoate copolymer; Styrene/MA copolymer; Styrene/PVP copolymer; Sucrose acetate isobutyrate; Sucrose benzoate; Sucrose benzoate/sucrose acetate isobutyrate/butyl benzyl phthalate/methyl methacrylate copolymer; Sucrose benzoate/sucrose acetate isobutyrate/butyl benzyl phthalate copolymer; Sucrose benzoate/sucrose acetate isobutyrate copolymer; Tea-acrylates/acrylonitrogens copolymer; Tricontanyl PVP; Trimethylpentanediol/isophthalic acid/trimellitic anhydride copolymer; Tromethamine acrylates/acrylonitrogens copolymer; VA/butyl maleate/isobomyl acrylate copolymer; VA/crotonates/methacryloxybenzophenone-1 copolymer; VA/crotonates/vinyl neodecanoate copolymer; VA/crotonates/vinyl propionate copolymer; VA/crotonates copolymer; VA/DBM copolymer; VA/isobutyl maleate/vinyl neodecanoate copolymer; VA/vinyl butyl benzoate/crotonates copolymer; Vinyl acetate; and Vinyl caprolactam/PVP/dimethylaminoethyl methacrylate copolymer.

In some embodiments, the film-forming resin can be an epoxy, vinyl, alkyd, polyester, acrylic, aminoplast, phenolplast, cellulose derivative, amide or urethane resin or mixtures thereof. Copolymers derived from such resins are also useful herein.

The epoxide resins used as a film-forming resin in the tinting compositions are those compounds having a 1,2-epoxy group, i.e.,

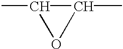

present in the molecule. Polyepoxides contain more than one 1,2-epoxy group per molecule. In general, the epoxide equivalent weight will range from about 140 to about 4,000. These polyepoxides are saturated or unsaturated, cyclic or acyclic, aliphatic, alicyclic, aromatic or heterocyclic. They can contain substituents such as halogen, hydroxyl and ether groups.

One useful class of polyepoxides comprises the epoxy polyethers obtained by reacting an epihalohydrin (such as epichlorohydrin or epibromohydrin) with a polyphenol in the presence of an alkali. Suitable polyphenols include resorcinol, catechol, hydroquinone, bis(4-hydroxyphenyl)-2,2-propane, i.e., bisphenol A; bis(4-hydroxyphenyl)-1,1-isobutane;4,4-dihydroxybenzophenone; bis(4-hydroxyphenyl)-1,1-ethane; bis(2-hydroxynaphenyl)-methane; and 1,5-hydroxynaphthalene. One very common polyepoxide is a polyglycidyl ether of a polyphenol, such as bisphenol A.

Another class of epoxy resins are the polyglycidyl ethers of polyhydrix alcohols. These compounds may be derived from such polyhydric alcohols as ethylene glycol, diethylene glycol, triethylene glycol, 1,2-propylene glycol, 1,4-butylene glycol, 1,5-pentanediol, 1,2,6-hexanetriol, glycerol, trimethylolpropane, and bis(4-hydroxycyclohexyl)-2,2-propane.

Another class of epoxide resins are the polyglycidyl esters of polycarboxylic acids. These compounds are produced by the reaction of epichlorohydrin or a similar epoxy compound with an aliphatic or aromatic polycarboxylic acid such as oxalic acid, succinic acid, glutaric acid, terephthalic acid, 2,6-naphthalene dicarboxylic acid and dimerized linoleic acid.

Still another class of polyepoxides are derived from the epoxidation of an olefinicially unsaturated alicyclic compound. These polyepoxides are non-phenolic and are obtained by epoxidation of alicyclic olefins, for example, by oxygen and selected metal catalysts, by perbenzoic acid, by acid-aldehyde monoperacetate or by peracetic acid. Among such polyepoxides are the epoxy alicyclic ethers and esters well known in the art.

Useful polyepoxides also include those containing oxyalkylene groups in the epoxy molecule. Such oxyalkylene groups have the general formula:

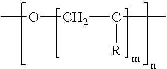

where R is hydrogen or alkyl, preferably a lower alkyl having from 1 to 6 carbon atoms, m is 1 to 4 and n is 2 to 50. Such groups are pendant to the main molecular chain of the polyepoxide or are part of the main chain itself. The proportion of oxyalkylene groups in the polyepoxide depends upon many factors, including the chain length of the oxyalkylene group, the nature of the epoxy and the degree of water solubility desired.

Another class of polyepoxides consists of the epoxy novolac resins. These resins are obtained by reacting an epihalohydrin with the condensation product of aldehyde and monohydric or polyhydric phenols. A typical example is the reaction product of epichlorohydrin with a phenolformaldehyde condensate.

Any well-known curing reactant for the above-described epoxy resin is normally included in the tinting composition. It is well known, chemicals and resins containing functional groups with active hydrogen groups are useful as curing agents for the epoxy resins. Generally, the curing agents cause polymerization by cross-linking of the epoxy molecules. Amine and polyamide catalysts are especially preferred curing agents.

Vinyl resins used in the tinting compositions are derived from monomers containing a carbon to carbon double bond. These monomers polymerize by linear addition to form long chain molecules. Generally, the polymeric resins have the structure:

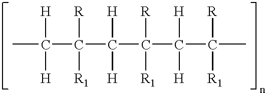

where R and R₁ represent various pendant groups such as hydrogen, chlorine, acetate, benzene and toluene. The vinyl resins are commonly derived from the monomers vinyl chloride, vinylidene chloride, vinyl acetate, the vinyl acetals, styrene, acrylonitrile and mixtures thereof. The vinyl polymers and copolymers range from about 100 to 10,000 carbon atoms in chain length and can be formed by bulk, solvent, suspension or emulsion polymerization.

Copolymers derived from mixtures of any of the aforedescribed vinyl monomers either with themselves or with other commonly used polymerizable monomers are used herein. Such copolymers possess a wide range of properties and can be formulated to fit individual needs.

One class of resins especially useful herein are the alkyd resins. Such resins are polyesters of polyhydroxyl alcohols and polycarboxyl acids chemically combined with various drying, semi-drying and non-drying oils in different proportions. Thus, for example, the alkyd resins are made from polycarboxylic acids such as phthalic acid, maleic acid, fumaric acid, isophthalic acid, succinic acid, adipic acid, azelaic acid, sebacic acid as well as from anhydrides of such acids, where they exist. The polyhydric alcohols which are reacted with the polycarboxylic acid include glycerol, trimethylolethane, trimethylolpropane, pentaerythritol, sorbitol, mannitol, ethylene glycol, diethylene glycol and 2,3-butylene glycol.

The alkyd resins are produced by reacting the polycarboxylic acid and the polyhydric alcohol together with a drying, semi-drying or non-drying oil in proportions depending upon the properties desired. The oils are coupled into the resin molecule by esterification during the manufacturing and become an integral part of the polymer. The oil is fully saturated or predominately unsaturated. The fully saturated oils tend to give a plasticizing effect to the alkyd, whereas the predominately unsaturated oils tend to cross-link and dry rapidly with oxidation to give more tough and durable alkyd resins. Suitable oils include coconut oil, fish oil, linseed oil, tung oil, castor oil, cottonseed oil, safflower oil, soybean oil, and tall oil. Various proportions of the polycarboxylic acid, polyhydric alcohol and oil are used to obtain alkyd resins of various properties.

Also useful herein are polyester type resins. As conventionally used and as used herein, the term “polyester” is applied to resins which contain no oil or fatty acid modification. That is, while the above-described alkyd resins are in the broadest sense polyester type resins, they are oil-modified and thus not generally considered a polyester resin. The polyesters are of two kinds. The more common are the unsaturated polyesters derived from unsaturated polyfunctional acids and polyhydric alcohol. These polyesters are essentially linear in structure. Maleic acid and fumaric acid are the usual unsaturated acid components. Commonly used polyhydric alcohols are ethylene glycol, propylene glycol, diethylene glycol, dipropylene glycol, butylene glycol, glycerol, trimethylol propane, pentaerythritol and sorbitol. Oftentimes a saturated acid will be included in the reaction to provide desirable properties. Examples of saturated acids include phthalic acid, isophthalic acid, adipic acid, azelaic acid, sebacic acid and the anhydrides thereof where they exist. The saturated polyesters are derived from saturated or aromatic polyfunctional acids, preferably dicarboxylic acids, and mixtures of polyhydric alcohols having an average hydroxyl functionality greater than 2.

Useful acrylic resins are the polymerized ester derivatives of acrylic acid and methacrylic acid. The resins contain the units

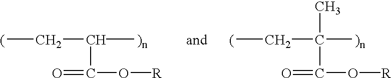

respectively. The esters are formed by the reaction of acrylic or methacrylic acid with suitable alcohols, e.g., methyl alcohol, ethyl alcohol, propyl alcohol, butyl alcohol and 2-ethylhexyl alcohol. Generally speaking, the larger the alcohol portion of the ester, the softer and more flexible the resultant resin. Also, generally speaking, the methacrylate esters form harder films than the corresponding acrylic esters. Monomers such as styrene, vinyl toluene, vinyl chloride and vinylidine chloride may be reacted with the acrylic and methacrylic esters so as to produce resins with excellent properties.

Thermosetting acrylic resins are normally low molecular weight copolymers made from 2 and sometimes 3 monomers. One of the monomers is an acrylic compound containing pendant reactive groups such as carboxyl, hydroxyl or amide. Another is an acrylic ester. The third monomer is usually a styrene type monomer such as styrene itself, vinyl toluene, methyl styrene or ethyl styrene. The proportions of the three components in the polymerization procedure are varied depending on the products in which the copolymer will be used.

Another class of film-forming resins useful in the tinting compositions herein is the amino resins commonly referred to as aminoplasts. The amino resins are made by the reaction of an amine with an aldehyde. The more important and preferred amines are urea and melamine. The aldehyde component comprises from 1 to 4 carbon atoms, with formaldehyde being the preferred aldehyde. Films of varying properties can be obtained by changing the proportions of the amine and aldehyde and by adding various chemically-reactive materials during the resin formation. Oftentimes, a lower alcohol, especially butanol, is added during the resin formation to impart desirable properties to the amino resin.

The phenolic resins commonly referred to as phenoplasts are also useful film-formers in the context of the subject invention. The phenolic resins are obtained by the condensation of phenol or substituted phenols with aldehydes. The monohydric phenols such as phenol, cresol and xylanol are the most important since they are readily available and relatively inexpensive. Phenol is the most preferred monohydric phenol. Polyhydric phenols such as resorcinol can also be used herein. Formaldehyde is the preferred aldehyde used in the production of the phenolic resins. Other aldehydes which are also useful include acetaldehyde, butyraldehyde and furfuraldehyde. The preferred phenolic resin is produced by the condensation of phenol and formaldehyde.

Different cellulose derivatives useful herein include nitrocellulose, cellulose acetate, cellulose acetate butyrate and ethyl cellulose. These film-forming materials are well known and are commercially available in varying degrees of substitution and molecular weight. Nitrocellulose is the preferred cellulose derivative.

Amide resins found to be useful include those polymers made by condensing a diamine with a dibasic acid. They are characterized by recurring amide groups, —CONH—, as an integral part of the main polymer chain. Examples of diamines used in producing the polyamide resins include ethylenediamine, diethylenetriamine and hexamethylenediamine. The carboxylic acids are the preferred dibasic acids and include adipic acid, sebacic acid, succinic acid, glutaric acid and azelaic acid.

Another class of film-formers used in embodiments of the invention herein are the urethane resins. These are synthetic polymers that may be either thermoplastic or thermosetting. The basic polymeric unit is —RNHCOOR—. The R groups can be the same or different and can contain other reactive groups, for example, a second —NCO group, a second —OH group, etc. Typically, a polyhydric alcohol is reacted with a polyisocyanate to produce the urethane resin. Useful polyhydric alcohols include ethylene glycol, propylene glycol, butylene glycol, glycerol, trimethylolpropane and hexane triol. Many variations are possible.

The urethane coating can be made from a one-pack or two-pack system. The one-pack urethane contains either an isocyanate prepolymer or a blocked isocyanate. The prepolymers are prepared by the reaction of excess diisocyanate with a polyhydric alcohol. Blocked isocyanates contain no free isocyanate groups and are relatively inactive at room temperature. At elevated temperatures, the compounds dissociate and undergo reactions typical of isocyanates. Typical blocking agents are phenols, thiols, tertiary alcohols and secondary aromatic amines. In a two-pack coating system, typically a polyester polyol and an isocyanate (or isocyanate prepolymer for safety reasons) are mixed at the time of application and applied immediately.

In certain embodiments, the solvent used in the tinting composition is a mixture of straight and branched chain hydrocarbons and a polydimethylsiloxane. In some embodiments, the solvent used in the tinting composition is a mixture of straight and branched chain hydrocarbons and a mixture of polydimethylsiloxanes. In certain embodiments, the solvent used in the tinting composition is a mixture of straight and branched chain hydrocarbons and a mixture of polydimethylsiloxanes having varying viscosities. In one such embodiment, a mixture of polydimethylsiloxanes having viscosities of 50 cst, 100,000 cst, and 8,000,000-12,000,000 cst is used. In other such embodiments, a mixture of polydimethylsiloxanes having an overall viscosity of 50,000-60,000 cst is used. In other embodiments, the solvent used in the tinting composition is a straight chain hydrocarbon, a branched chain hydrocarbon, or a polydimethylsiloxane.

Suitable pigments for use in preparing the tinting composition include, but are not limited to, iron oxide, titanium dioxide, mica, calcium sodium borosilicate, organic constituent containing pigments, inorganic constituent containing pigments, fluorescent constituent containing pigments, phosphorescent constituent containing pigments, luminescent constituent containing pigments, ultraviolet absorbing pigments, mineral constituent containing pigments, amorphous glass oxides, polyacrylates, metal flakes, reflective pigments, and mixtures thereof. The selection of the pigment coloration also varies based upon the color choice and intensity of color one wishes to be able to impart onto the surface. In certain embodiments, the pigment is an inorganic constituent containing pigment. A preferred pigment is mica coated with titanium dioxide or iron oxide such as Mearlin® Hi-Lite Sparkle Green, Mearlin® Hi-Lite Sparkle Blue, Mearlin® Hi-Lite Sparkle Gold, Mearlin® Hi-Lite Sparkle Red, Mearlin® Sparkle Russet, Exterior Mearlin® Sparkle, Mearlin® Sparkle Brass, Mearlin® Sparkle Bronze, Mearlin® Sparkle Copper, Mearlin® Hi-Lite Super Green, Mearlin® Hi-Lite Super Blue, Mearlin® Hi-Lite Super Red, Mearlin® Plum, Mearlin® Kiwi Green, Mearlin® Adobe Green, Mearlin® Firemist Red, and Mearlin® Firemist Blue made by Engelhard Corporation, Microlith Yellow made by Ciba Specialty Chemicals, and Helicon® HC made by Wacker. Additional pigments include, but are not limited to, pigments sold by Engelhard Corporation such as the Mearlin® Magnapearls & White Pearlescents, the Mearlin® White Pearlescents, the Mearlin® Hi-Lite Interference Colors, the Mearlin® Dynacolor Luster Pigments, the Mearlin® “Non-Metallic” Metallic Colors, the Mearlin® Santa Fe Colors, the Mearlin® Micro Pearls, the Mearlin® Sparkle Colors, the Mearlite® Industrial Grades, the Mearlin® Firemist pigments, and the Mearlin® Vegetable Colors.

Generally, the pigment is present in the tinting composition in an amount from about 0.001 to about 60 wt. % of the tinting composition. In certain embodiments, the pigment is present in an amount from about 0.1 to about 50 wt. % of the tinting composition. In certain other embodiments, the pigment is present in an amount from about 0.1 to about 25 wt. % of the tinting composition.

In addition to a solvent and a pigment, the tinting composition may further include one or more of the following components: thickener flow modifiers, corrosion inhibitors, thickeners, surface tension reducers, silica, emulsifiers, fragrance, release agents, wetting agents, ultraviolet additives, and other additives to add or enhance the desired properties of the tinting composition. The use of these optional components and the desired amounts of each component is based upon the desired properties of the tinting composition such as the degree of coloration and the viscosity of the tinting composition; the shelf life of the tinting composition; the desired scent of the tinting composition; and the means used to apply the tinting composition to the surface. In some embodiments, reflective materials or retroreflective materials are used in place of or in addition to a pigment. Any reflective or retroreflective materials or particles may be used. For example, U.S. Pat. Nos. 4,915,935; 4,983,458; and 5,939,716 disclose various reflective particles which may be used in embodiments of the invention, the disclosures of the patents are incorporated by reference herein in their entirety. U.S. Pat. Nos. 6,066,384 and 5,998,525 disclose various retroreflective particles or fillers which may be used in embodiments of the invention. The disclosures of the patents are incorporated by reference herein in their entirety.

In some embodiments, silica is added to the tinting composition to aid in suspending the pigment within the tinting composition. The silica that is selected for use in the tinting composition can be used either alone or in combination in varying proportions with other silica. Examples of suitable silica which can be used in the present invention include, but are not limited to, fumed silica such as Aerosil® R202 made by Degussa-H\dot{u}ls and CAB-O-SIL® TS720 made by Cabot Corporation, amide powder, rheology additives, clays, surfactants, cellulose gums, carbomers, precipitated silica such as Zeothix 265 made by J. M. Huber Corporation, and mixtures thereof although other silica may also be used. A preferred silica used in embodiments of the invention is fumed silica. Generally, silica is present in the tinting composition in an amount from about 0.001 to about 30 wt. % of the tinting composition. In certain embodiments, the silica is present in an amount from about 0.01 to about 15 wt. % of the tinting composition. In certain other embodiments, the silica is present in an amount from about 0.1 to about 10 wt. % of the tinting composition.

In some other embodiments, an emulsifier is added to the tinting composition to aide in holding the components of the tinting composition into solution, to thicken the suspension of the tinting composition, and to serve as a dispersant for the pigment. It is desired to use an emulsifier in the tinting composition where the solvent is water in order to thicken the suspension of the tinting composition. Suitable emulsifiers include, but are not limited to, nonionic, cationic, anionic and amphoteric surfactants, block polymers, block copolymers, acrylics, primary and secondary emulsifiers, and mixtures thereof although other emulsifiers may also be used. The emulsifier that is selected for use in the tinting composition can be used either alone or in combination in varying proportions with other emulsifiers. Generally, an emulsifier is present in the tinting composition in an amount from about 0.001 to about 20 wt. % of the tinting composition. In certain embodiments, the emulsifier is present in an amount from about 0.1 to about 15 wt. % of the tinting composition.

Any emulsifying agent or emulsifier may be used in embodiments of the invention. Suitable emulsifying agents include, but are not limited to the following compounds identified by the INCI names: 7-dehydrocholesterol; Abietic acid; Acetylated glycol stearate; Avocadamide DEA; Bentonite; Beta-sitosterol; C₁₂₋₁₃ alcohols; C₁₂₋₁₅ alcohols; C₁₂₋₁₆ alcohols; C₁₅₋₁₈ glycol; C₂₂₋₂₄ pareth-33; C₉₋₁₁ alcohols; Calcium carrageenan; Carbomer; Carboxymethyl hydroxyethylcellulose; Carboxymethyl hydroxypropyl guar; Carrageenan; Cellulose gum; Cera microcristallina; Ceresin; Cetearyl alcohol; Cocamide; Cocamide DEA; Cocamide MEA; Cocamide MIPA; Cocamidopropyl lauryl ether; Dihydroxyethyl cocamine oxide; Ethylene/acrylic acid copolymer; Ethylene/VA copolymer; Glycol cetearate; Hydrogenated C₁₂₋₁₈ triglycerides; Hydrogenated lanolin alcohol; Hydrogenated tallow amide; Hydroxybutyl methylcellulose; Hydroxyethyl ethylcellulose; Hydroxyethylcellulose; Hydroxypropyl guar; Hydroxypropyl methylcellulose; Hydroxypropylcellulose; Isopropyl ester of PVM/MA copolymer; Lanolinamide DEA; Lauryl alcohol; Maltodextrin; Methoxy PEG-22/dodecyl glycol copolymer; Methylcellulose; Microcrystalline cellulose; Montmorillonite; Myristyl alcohol; Oxyquinoline sulfate; Ozokerite; Palm kemelamide DEA; Palm kemelamide MEA; Palm kemelamide MIPA; Palmamide DEA; Palmamide MEA; Palmamide MIPA; Peanutamide MEA; Peanutamide MIPA; Pectin; PEG-115m; PEG-14m; PEG-20m; PEG-23m; PEG-2m; PEG-45/dodecyl glycol copolymer; PEG-5m; PEG-7m; PEG-90m; PEG-9m; Pentadecyl alcohol; Polyacrylic acid; Polyvinyl acetate; Potassium alginate; Potassium carrageenan; PVM/MA copolymer; PVP; PVP/dimethylaminoethylmethacrylate copolymer; PVP/VA copolymer; Saccharated lime; Scleroglucan; Sclerotium gum; Sodium acrylate/vinyl alcohol copolymer; Sodium C₄₋₁₂ olefin/maleic acid copolymer; Sodium carboxymethyl dextran; Sodium carrageenan; Sodium cellulose sulfate; Sodium polymethacrylate; Sodium polynaphthalenesulfonate; Sodium polystyrene sulfonate; Soyamide DEA; Stearic acid; Stearyl alcohol; Styrene/MA copolymer; Synthetic beeswax; Synthetic candelilla wax; Synthetic camauba; Synthetic japan wax; Synthetic wax; Tallow amide; Tallowamide DEA; Tallowamide MEA; Tetrasodium etidronate; Tridecyl alcohol; and Xanthan gum.

In some embodiments, a fragrance is added to provide a scent to the tinting composition. Any fragrance known in the art which imparts the desired scent to the tinting composition can be used. The fragrance that is selected for use in the tinting composition can be used either alone or in combination in varying proportions with other fragrances. Generally, a fragrance is present in the tinting composition in an amount from about 0.0001 to about 15 wt. % of the tinting composition. In certain embodiments, the fragrance is present in an amount from about 0.01 to about 5 wt. % of the tinting composition.

In some other embodiments, an ultraviolet additive is added to protect the tinting composition from the sunlight. Examples of suitable ultraviolet additives include, but are not limited to, free radical scavengers, antioxidants, hindered amines, antistatic agents, and mixtures thereof although other ultraviolet additives may also be used. The ultraviolet additive that is selected for use in the tinting composition can be used either alone or in combination in varying proportions with other ultraviolet additives. Generally, an ultraviolet additive is present in the tinting composition in an amount from about 0.001 to about 10 wt. % of the tinting composition. In certain embodiments, the ultraviolet additive is present in an amount from about 0.01 to about 5 wt. % of the tinting composition.

As described above, a number of ingredients or components may be present in the tinting composition in accordance with embodiments of the invention. The following table shows the weight percentages for each component. It should be recognized that these ranges are merely preferences and that not all listed components need to be present in the tinting composition. A composition falling outside the preferred ranges is still within the scope of the invention described and claimed herein. The weight percentages are based on the total weight of the tinting composition. It should be recognized that the ingredients or components of the tinting composition can be added in any order to prepare the tinting composition.

TABLE 1

| Component | Range (wt. %) | Preferred Range (wt. %) |
|---|---|---|
| Solvent | 0.1-99.9% | 50-99.9% |
| Pigment | 0.001-60% | 0.1-50% |
| Silica | 0-30% | 0.01-15% |
| Emulsifier | 0-20% | 0.1-15% |
| Fragrance | 0-15% | 0.01-5% |
| Ultraviolet Additive | 0-10% | 0.01-5% |
| Film Former | 0.01-25% | 0.5-15% |

Although various tinting compositions are disclosed, it should be understood that a coating composition comprising the components of a tinting composition except a pigment may be prepared in accordance with embodiments of the invention. The coating composition can be used for decoration or protection of articles. Any component suitable for formulating a tinting composition can be used in a composition. In some embodiments, a coating composition comprises at least one film-former and a carrier or solvent. Pigments can also be used if opacity or color is desired. Various coating additives can also be used to control the physical properties of the composition. Suitable film-formers can be one of the following polymeric materials: thermoset rubbers (crumb rubbers); thermoplastic rubbers or elastomers such as block copolymers whose hard segments in the polymer molecule consist of styrene and the soft segments isoprene, butadiene, ethylene-propylene, or ethylene-butylene; polyvinyl butyral; or mixtures thereof. Suitable carriers can be one of the following solvents: mineral oils; volatile hydrocarbons; ketones; esters; ethers; chlorohydrocarbons; fluorohydrocarbons; alcohols; glycols; or mixtures thereof. It should be understood that any of the components disclosed herein may be used in a coating composition. A coating composition may become a tinting composition when certain pigments are added.

The following are preferred embodiments for basic coating compositions. Composition A is a basic formulation. Composition B includes pigmentation. Composition C includes water, an emulsifier and pigmentation. The ranges given are for uses with a wide variety of release agents, solvents, emulsifiers, pigments.

TABLE 2
BASIC FORMULAS

| | A wt % | B wt % | C wt % |
|---|---|---|---|
| Polymer | 1-25 | 1-25 | 1-25 |
| Release Agent | 0.1-10 | 0.1-10 | 0.1-10 |
| Solvent | 5-90 | 5-50 | 50-90 |
| Emulsifier | | | 0.1-10 |
| Water | | | 5-50 |
| Pigment | | 0.1-40 | 0.1-10 |

The release agent in the above compositions may be a silicone, an organo silicone or a long chain fatty acid ester or polyester. The solvent may be a 1:1 volume of toluene/mixed heptanes, mineral spirits or blends thereof. The emulsifier may be a polyacrylate or a nonionic surfactant. The polymer may be a styrene/butylene copolymer which may further be functionalized. The above compositions may further include a film former, a wetting agent (surfactant), neutralizers.

The following examples are presented to illustrate various embodiments of the invention. All numerical values are approximate numbers. The specific details in each example should not be construed to limit the invention as otherwise described and claimed herein. The following tables show various tinting compositions made in accordance with embodiments of the invention. The amount of each component added to each tinting composition is provided in weight percent of the total composition.

### EXAMPLE 1

| | | CHEMICAL | PRINCIPLE | |
|---|---|---|---|---|
| INGREDIENT | SUPPLIER | NAMES | FUNCTION | wt. % |
| Luviskol k-60 | BASF | Polyvinyl- | Film former | 5 |
| | | pyrrolidone | | |
| | | (MW 350,000) | | |
| PhosFlex | Azko Nobel | Tributoxyethyl | Flow modifier | 1 |
| | | phosphate | | |
| Zonyl | Dupont | Fluoro- | Surface tension | 0.1 |
| | | surfactant | reduction | |
| Pigment-dye | | | | 0.5 |
| IPA | | Isopropanol | Solvent | 93.4 |
| Total | | | | |

Note:
the polymer Luviskol k-60 can be replaced by other polymers: PVP-VA I-335 (available from ISP Technologies); PVP/Vinyl Acetate; Gantrez ES-435 (available from ISP Technologies); or Butyl ester of PVM/MA copolymer.

### EXAMPLE 2

| INGREDIENT | SUPPLIER | wt. % |
|---|---|---|
| Penreco Ultima Petrolatum | Penreco | 2 |
| AP-200 Silicone | Wacker | 2 |
| Igepal DAP-9 | Witco | 0.2 |
| Dupont R-900 TiO2 | Dupont | 15 |
| 15% Kraton G-1652 in Cypar 9 | | 70.8 |
| Kraton | Shell | 10.62 |
| Cypar 9 | Shell | 60.18 |
| Dye-pigment | Day-Glow | 10 |
| Total Ingredients | | 100 |

### EXAMPLE 3

This example is preferably used for inorganic surfaces such as glass or metals.

| Ingredient | Wt. % |
|---|---|
| Crumb rubber | 8.5% |
| Tetrachloroethelene | 76% |
| Silicone oil | 0.5% |
| White pigment | 5% |
| Color pigment | 10% |

### EXAMPLE 4

This example forms a clear and flexible coating and can be used for various surfaces.

| Ingredient | Wt. % |
|---|---|
| Thermoplastic rubber such as Styrene- | 5-30% |
| ethylene/butylenes-styrene block copolymer | |
| Mineral oil | 10-80% |
| Volatile organic solvent | 0-50% |

### EXAMPLE 5

This example forms a color coating.

| Ingredient | Wt. % |
|---|---|
| Thermoplastic rubber such as Styrene- | 20% |
| ethylene/butylenes-styrene block copolymer | |
| Mineral oil | 55% |
| di-isobutyl ketone | 10% |
| White pigment | 5% |
| Color pigment | 10% |

### EXAMPLE 6

This example forms a clear and flexible coating and can be used for various surfaces.

| Ingredient | Wt. % |
|---|---|
| polyvinyl butyral | 5-30% |
| Low alcohol solvent | 45-95% |
| Release agent | 0-2% |
| Antifoaming/defoaming agent | 0-2% |
| White pigment | 0-10% |
| Color pigment | 0-10% |

The following examples form a clear and flexible coating and can be used for various surfaces.

| Component | Example 7 | Example 8 | Example 9 |
|---|---|---|---|
| Polymer | 50 | 50* | 50 |
| Surfactant | 0.6 | 0.6 | 0.6 |
| Emulsifier | 0.15 | 0.15 | 0.3 |
| Water | 49.025 | 49.025 | 48.65 |
| Neutralizer | 0.225 | 0.225 | 0.45 |

*also includes 2% release agent

The polymer in the above examples can be represented by a 10% solution of Kraton G-1652 from Kraton Polymers (Houston, Tex.) in mineral spirits. The surfactant of the above example can be represented by Igepal CO-530 from Rohm and Haas (Philadelphia, Pa.). The emulsifier can be represented by Pemulen 1622 from Noveon, Inc. (Cleveland, Ohio). The neutralizer can be represented by AMP-95 by 2-amino-2-methyl-1-propanol that is 95% active from Angus Chemical (Buffalo Grove, Ill.). The release agent can be represented by Ketjenlube 165 from Akzo Noble (Chicago, Ill.).

The following examples show the variety of polymers, surfactants, solvents and release agent components that can be utilized to produce a clear and flexible coating which can be used for various surfaces. Wetting agents were added to the compositions to improve the application of the compositions.

| | Polymer | Wetting Agent | Solvent | Release |
|---|---|---|---|---|
| | (A, B or C) | (A, B, or C) | (A, B, or C) | Agent |
| Example 10 | 5 (A) | 0.5 (A) | 94.5 (A) | 0 |
| Example 11 | 7.5 (B) | 0.5 (A) | 92 (A) | 0 |
| Example 12 | 7.5 (B) | 0.5 (A) | 91.0 (B) | 1.0 |
| Example 13 | 7.5 (B) | 0.5 (A) | 91.0 (B) | 1.0 |
| Example 14 | 7.5 (B) | 0.5 (A) | 91.0 (A) | 1.0 |
| Example 15 | 10 (C) | 0.5 (A) | 89.5 (A) | |
| Example 16 | 7.5 (B) | 0.5 (A) | 91.0 (C) | 1.0 |
| Example 17 | 7.5 (B) | 0.5 (B) | 91.0 (B) | 1.0 |
| Example 18 | 7.5 (B) | 0.5 (B) | 91.0 (B) | 1.0 |
| Example 19 | 7.5 (B) | 0.5 (B) | 91.0 (B) | 1.0 |
| Example 20 | 7.5 (B) | 0.5 (C) | 91.0 (A) | 1.0 |
| Example 21 | 7.5 (B) | 0.5 (C) | 91.0 (A) | 1.0 |

The polymers in the above examples can be represented by (A) Kraton G-1651, (B) Kraton G-1652 and (C) Kraton G-1725 all from Kraton Polymers (Houston, Tex.). The wetting agents in the above examples can be represented by (A) Monazoline O from UNIQEMA (New Castle, Del.), (B) Miramine CC from Aventis (Bridgewater, N.J.) and (C) Monazoline T from UNIQEMA (New Castle, Del.). The release agent in the above examples can be represented by Ketjenlube 165 by Akzo Nobel (Chicago, Ill.). The solvents in the above examples can be represented by (A) 45:50 chlorobenzene/VM&P naphtha, (B) 45:50 perchloroethylene/VM&P naphtha, and (C) 2-chloro-toluene/VM&P naphtha. Most of the compositions produced a clear formulation. The compositions with wetting agent (A) appeared to have an improved wetting effect on tire samples.

The following examples have a cross-linking agent added to the coating composition. The cross-linking agent promotes adhesion within the formula, not of the formula to the surface.

| | Polymer | Wetting | Solvent | Release | Cross-linking |
|---|---|---|---|---|---|
| | (A, B, C, or D) | Agent | (A, B, C, D) | Agent | Agent (A, B, or C) |
| Example 22 | 7.5 (A) | 0 | 90.5 (A) | 1.0 | 1.0 (A) |
| Example 23 | 7.5 (A) | 0 | 90.5 (A) | 1.0 | ;1.0 (B) |
| Example 24 | 7.5 (B) | 0 | 90.5 (A) | 1.0 | 1.0 (A) |
| Example 25 | 5.0 (D) | 0 | 93.0 (A) | 1.0 | 1.0 (A) |
| Example 26 | 5.0 (A) | 0 | 93.0 (B) | 1.0 | 1.0 (C) |
| Example 27 | 7.5 (C) | 0 | 90.0 (C) | 1.0 | 2.0 (C) |
| Example 28 | 15.0 (C) | 0 | 80.0 (C) | 2.0 | 2.0 (C) |
| | | | 1.0 (D) | | |
| Example 29 | 11.25 (C) | 0 | 85.0 (C) | 1.5 | 1.5 (C) |
| Example 30 | 7.5 (C) | 0.5 | 89.5 (C) | 1.0 | 1.0 (C) |
| | | | 0.5 (D) | | |

The polymers in the above examples can be represented by (A) Kraton G-1652, (B) Kraton G-1726, (C) Kraton G-1726M all from Kraton Polymers (Houston, Tex.) and (D) TUFTEC M1913 from Marubeni America Corporation (NY, N.Y.). The release agent in the above examples can be represented by Ketjenlube 165 by Akzo Nobel (Chicago, Ill.). The solvents in the above examples can be represented by (A) 30:70 perchloroethylene/heptanes, (B) perchloroethylene, (C) 1:1 toluene/heptanes, and (D) Wacker 1000 Cs Silcone from Wacker Chemical (Adrian, Mich.) and mixtures thereof. The wetting agents in the above examples can be represented by Surfadone LP-300 from International Specialty Products (Wayne, N.J.). The cross-linking agents in the above examples can be represented by (A) octadecenyl succinic acid (ODSA), (B) Dimer acid diglycidyl ester, (C) and EDENOL 9232 (ESBO) from Henkel KgaA (Hayward, Calif.). The above compositions were tested for opacity of the solution and adhesion to tires.

The following example is for a tire coating composition that may be packaged in an aerosol can.

### EXAMPLE 31

| Ingredient | Wt. % |
|---|---|
| Polymer A | 4.0 |
| Polymer B | 3.5 |
| Release Agent | 1.0 |
| Solvent A | 0.5 |
| Solvent B | 90.0 |
| Cross-linking Agent | 1.0 |

The polymers in the above examples can be represented by (A) Kraton G-1726M, and (B) Kraton G-1652 both from Kraton Polymers (Houston, Tex.). The release agent in the above example can be represented by Ketjenlube 165 by Akzo Nobel (Chicago, Ill.). The solvents in the above examples can be represented by (A) 1:1 toluene/heptanes and (B) Wacker 1000 Cs Silcone from Wacker Chemical (Adrian, Mich.) and mixtures thereof. The cross-linking agents in the above examples can be represented by EDENOL 9232 (ESBO) by Henkel KGaA (Hayward, Calif.).

The following examples have a pigment added to the coating composition. The pigments impart a color to the surface it is applied to. The surfaces it may be applied to include tires, glass, and paint.

| | | Surfactant | | Release | |
|---|---|---|---|---|---|
| | Polymer | (A, B, C, D, E, | | Agent | Pig- |
| | and Solvent | F, G, H, or I | Solvent | (A or B) | ment |
| Example 32 | 94.0 | 2.0 (A) | 2.0 (A) | | 2.0 |
| Example 33 | 94.0 | 2.0 (B) | 2.0 (A) | | 2.0 |
| Example 34 | 94.0 | 2.0 (C) | 2.0 (A) | | 2.0 |
| Example 35 | 94.0 | 2.0 (D) | 2.0 (A) | | 2.0 |
| Example 36 | 94.0 | 2.0 (E) | 2.0 (A) | | 2.0 |
| Example 37 | 92.0 | 2.0 (F) | 2.0 (A) | 2.0 (A) | 2.0 |
| Example 38 | 94.0 | 2.0 (G) | 2.0 (A) | | 2.0 |
| Example 39 | 94.0 | 2.0 (H) | 2.0 (A) | | 2.0 |
| Example 40 | 94.0 | 2.0 (I) | 2.0 (A) | | 2.0 |
| Example 41 | 94.0 | 2.0 (I) | | 2.0 (A) | 2.0 |
| Example 42 | 90.0 | 2.0 (A) | 2.0 (A) | 2.0 (A) | 2.0 |

The polymer and solvent component in the above examples can be represented by 10% Kraton G-1652 in a 1:1 volume of toluene and heptanes. The release agents in the above examples can be represented by (A) Super Petrolatum from Penreco (Houston, Tex.) or (B) OZOKERITE 77Y Wax from Frank B. Ross Co. (Jersey City, N.J.). The solvent (A) in the above examples can be represented by Wacker 1000 Cs Silcone from Wacker Chemical (Adrian, Mich.). The surfactants in the above examples can be represented by (A) Witco Varonic Q202 from Crompton Corporation (Greenwich, Conn.), (B) Igepal CO-530 from Rohm and Haas (Philadelphia, Pa.), (C) Ethomeen 0/15 from Akzo Nobel (Chicago, Ill.), (D) Chemeen 18-2 from Chemtex (East Providence, R.I.), (E) Chemeen 18-5 from Chemtex (East Providence, R.I.), (F) Monazoline O from UNIQEMA (New Castle, Del.), (G) Chemal OA-5 from Chemax, Inc. (Greenville, S.C.), (H) Surfadone LP-300 from International Specialty Products (Wayne, N.J.), and (I) Witconate R-1059 from Thomley Co. (Wilmington, Del.). The pigment may be represented by SBT-353GN from Silverline Manufacturing Co. (Tamaqua, Pa.). The pigments may also be any color.

Examples which have pigments, may further have titanium dioxide (<5 microns) added to the composition. The titanium oxide provides opacity to the composition and enhances the pigmentation.

While the invention has been described with respect to a number of limited embodiments, variations and modifications exist. For example, although the invention is described with reference to vehicles, the application of the invention is not limited only to use on vehicles. U.S. Pat. Nos. 4,339,365; 5,340,390; 5,707,697; and 6,187,233B1 disclose various coating compositions and method of using same. The various components and method of use may be used in embodiments of the invention with or without modifications. All of the preceding patents are incorporated by reference herein in their entirety. Additional objects on which the tinting composition may be used include, but are not limited to, bicycles, motorcycles, campers, motor homes, recreational vehicles, trucks, roller blades, boats, and canoes. Also, other surfaces described herein can be tinted regardless of whether the surface is in or on a vehicle or other objects specifically referenced. The appended claims intend to cover all such variations and modifications as falling within the scope of the invention as described herein.

What is claimed is:

1. A tinting composition for tinting a surface comprising:
a solvent in the amount from about 50 to about 99 wt %;
a film former in the amount from about 0.01 to about 25 wt %; and
a pigment in the amount from about 0.001 to about 60 wt % selected from the group consisting of iron oxide, titanium dioxide, mica, calcium sodium borosilicate, organic constituent containing pigments, inorganic constituent containing pigments, fluorescent constituent containing pigments, phosphorescent constituent containing pigments, luminescent constituent containing pigments, ultraviolet absorbing pigments, mineral constituent containing pigments, amorphous glass oxides, polyacrylates, metal flakes, reflective pigments, and mixtures thereof.

2. The tinting composition of claim 1, wherein the surface is a polymeric substrate.

3. The tinting composition of claim 2, wherein the polymeric substrate is selected from the group consisting of rubber, engineered plastic, and vinyl.

4. The tinting composition of claim 2, wherein the polymeric substrate is selected from the group consisting of the surface of a tire, dashboard, bumper, steering wheel, mudflap, and seat.

5. The tinting composition of claim 1, wherein the surface is selected from the group consisting of metal, glass, fiberglass, plastic, and paint.

6. The tinting composition of claim 1, wherein the solvent is selected from the group consisting of branched or straight chained aliphatic hydrocarbons, synthetic hydrocarbons, alcohols, water, organic solvents, silicone fluids, paraffinic solvents, volatile solvents, and mixtures thereof.

7. The tinting composition of claim 1, wherein the solvent is a silicone fluid comprising polydimethylsiloxane.

8. The tinting composition of claim 7, wherein the polydimethylsiloxane has a viscosity ranging from about 0.65 cst to about 12,000,000 cst.

9. The tinting composition of claim 1, wherein the solvent is a mixture of straight and branched chain hydrocarbons.

10. The tinting composition of claim 1, wherein the solvent is a mixture of straight and branched chain hydrocarbons and a silicone fluid comprising polydimethylsiloxane.

11. The tinting composition of claim 1, wherein the pigment is an inorganic constituent containing pigment.

12. The tinting composition of claim 1, wherein the pigment is selected from the group consisting of mica coated with titanium dioxide and mica coated with iron oxide.

13. The tinting composition of claim 1, further comprising silica.

14. The tinting composition of claim 13, wherein the silica comprises from about 0.001 to about 60 wt. % of the tinting composition.

15. The tinting composition of claim 13, wherein the silica is selected from the group consisting of fumed silica, amide powder, rheology additives, clays, surfactants, cellulose gums, carbomers, precipitated silica, and mixtures thereof.

16. The tinting composition of claim 1, further comprising an emulsifier.

17. The tinting composition of claim 16, wherein the emulsifier comprises from about 0.001 to about 20 wt. % of the tinting composition.

18. The tinting composition of claim 17, wherein the emulsifier is selected from the group consisting of nonionic, cationic, anionic and amphoteric surfactants, block polymers, block copolymers, acrylics, primary and secondary emulsifiers, and mixtures thereof.

19. The tinting composition of claim 1, further comprising fragrance.

20. The tinting composition of claim 19, wherein the fragrance comprises from about 0.0001 to about 20 wt. % of the tinting composition.

21. The tinting composition of claim 1, further comprising an ultraviolet additive.

22. The tinting composition of claim 21, wherein the ultraviolet additive comprises from about 0.001 to about 10 wt. % of the tinting composition.

23. The tinting composition of claim 1, wherein the pigment comprises from about 0.1 to about 50 wt. % of the tinting composition.

24. The tinting composition of claim 1, wherein the solvent is a mixture of straight and branched chain hydrocarbons and a silicone fluid comprising polydimethylsiloxane and the pigment is an inorganic constituent containing pigment.

25. The tinting composition of claim 24, wherein the pigment is selected from the group consisting of mica coated with titanium dioxide and mica coated with iron oxide.

26. The tinting composition of claim 1, further comprising silica, emulsifier, fragrance and an ultraviolet additive.

27. The tinting composition of claim 26, wherein the silica comprises from about 0.001 to about 30 wt. %, the emulsifier comprises from about 0.001 to about 20 wt. %, the fragrance comprises from about 0.0001 to about 15 wt. % of the tinting composition, and the ultraviolet additive comprises from about 0.001 to about 10 wt. % of the tinting composition.

28. A tinting composition for tinting a surface comprising:
a solvent selected from the group consisting of branched or straight chained aliphatic hydrocarbons, synthetic hydrocarbons, alcohols, water, organic solvents, silicone fluids, paraffinic solvents, volatile solvents, and mixtures thereof;
a polyvinylpyrrolidone vinyl acetate copolymer;
a pigment selected from the group consisting of iron oxide, titanium dioxide, mica, calcium sodium borosilicate, organic constituent containing pigments, inorganic constituent containing pigments, fluorescent constituent containing pigments, phosphorescent constituent containing pigments, luminescent constituent containing pigments, ultraviolet absorbing pigments, mineral constituent containing pigments, amorphous glass oxides, polyacrylates, metal flakes, reflective pigments, and mixtures thereof; and
a silica selected from the group consisting of fumed silica, amide powder, rheology additives, clays, surfactants, cellulose gums, carbomers, precipitated silica, and mixtures thereof.

29. The tinting composition of claim 28, wherein the surface is a polymeric substrate.

30. The tinting composition of claim 29, wherein the polymeric substrate is selected from the group consisting of rubber, engineered plastic, and vinyl.

31. The tinting composition of claim 29, wherein the surface is selected from the group consisting of the surface of a tire, dashboard, bumper, steering wheel, mudflap, and seat.

32. The tinting composition of claim 28, wherein the surface is selected from the group consisting of metal, glass, fiberglass, paint, and plastic.

33. The tinting composition of claim 28, wherein the solvent is a mixture of straight and branched chain hydrocarbons and a silicone fluid comprising polydimethylsiloxane, the pigment is selected from the group consisting of mica coated with titanium dioxide and mica coated with iron oxide, and the silica is fumed silica.

34. The tinting composition of claim 28, wherein the tinting composition further comprises a fragrance.

35. A method of tinting a surface comprising:
selecting a surface for tinting;
mixing a solvent in the amount from about 50 to about 99.9 wt %, a film former in the amount from about 0.01 to about 25 wt %, and a pigment in the amount from about 0.001 to about 60 wt % selected from the group consisting of iron oxide, titanium dioxide, mica, calcium sodium borosilicate, organic constituent containing pigments, inorganic constituent containing pigments, fluorescent constituent containing pigments, phosphorescent constituent containing pigments, luminescent constituent containing pigments, ultraviolet absorbing pigments, mineral constituent containing pigments, amorphous glass oxides, polyacrylates, metal flakes, reflective pigments, and mixtures thereof to form a tinting composition; and applying the tinting composition to the surface.

36. The method of claim 35, further including the step of drying the tinting composition.

37. The method of claim 35, wherein the step of mixing further includes adding a silica.

38. The method of claim 35, wherein the step of mixing further includes adding an emulsifier.

39. The method of claim 35, wherein the step of mixing further includes adding a fragrance.

40. The method of claim 35, wherein the step of mixing further includes adding an ultraviolet additive.

41. The method of claim 35, wherein the step of applying is accomplished by spraying the tinting composition onto the surface.

42. The method of claim 35, wherein the step of applying is accomplished by one of the steps selected the group consisting of sponging, dabbing, painting and wiping the tinting composition onto the surface.

43. The method of claim 35, wherein the step of applying is accomplished by applying an adhesive which contains the tinting composition onto the surface and removing the adhesive.

44. The method of claim 35, wherein the surface is a polymeric substrate.

45. The method of claim 44, wherein the polymeric substrate is selected from the group consisting of rubber, engineered plastic, and vinyl.

46. The method of claim 44, wherein the polymeric substrate is selected from the group consisting of the surface of a tire, dashboard, bumper, steering wheel, mudflap, and seat.

47. The method of claim 35, wherein the surface is selected from the group consisting of metal, glass, fiberglass, paint, and plastic.

48. The method of claim 35, wherein the solvent comprises from about 50 to about 99.9 wt. % and the pigment comprises from about 0.1 to about 50 wt. % of the tinting composition.
